(19) United States
(12) Patent Application Publication
(10) Pub. No.: US 2017/0121452 A1
(43) Pub. Date: May 4, 2017

(54) EPOXY SYSTEM

(71) Applicant: BASF SE, Ludwigshafen am Rhein (DE)

(72) Inventors: Matthaeus KOPCZYNSKI, Ludwigshafen (DE); Michael HENNINGSEN, Frankenthal (DE); Miran YU, Worms (DE)

(73) Assignee: BASF SE, Ludwigshafen am Rhein (DE)

(21) Appl. No.: 15/342,759

(22) Filed: Nov. 3, 2016

(30) Foreign Application Priority Data
Nov. 3, 2015 (EP) 15192754.8

(51) Int. Cl. C08G 59/68; C08G 59/50; B29C 35/02; C08J 5/24; C08J 5/04; B29B 15/12; C08K 7/14; C08G 59/24

(52) U.S. Cl. CPC C08G 59/686; C08K 7/14; C08G 59/5033; C08G 59/245; C08J 5/24; C08J 5/043; B29B 15/12; B29C 35/02; C08G 2390/00; C08J 2363/02; B29K 2063/00

(57) ABSTRACT

The invention is directed to a curable composition, which comprises an epoxy resin mixture, wherein the epoxy resin mixture comprises
a) an epoxy resin;
b) diethyl methyl benzene diamine (DETDA) as hardener;
c) at least one compound selected from the group consisting of 1,8-diazabicyclo[5.4.0]undec-7-ene (DBU) and 1,5-diazabicyclo[4.3.0]non-5-ene (DBN) as catalyst.

The present invention is directed to a curable composition comprising an epoxy resin mixture, wherein the epoxy resin mixture comprises an epoxy resin; diethyl methyl benzene diamine (DETDA) as hardener; and at least one compound selected from the group consisting of 1,8-diazabicyclo[5.4.0]undec-7-ene (DBU) and 1,5-diazabicyclo[4.3.0]non-5-ene (DBN) as catalyst.

Fiber-reinforced plastics are composite materials made of a polymer matrix reinforced with fibers. Fibers typically used are glass fibers, carbon fibers, aramid fibers or nylon fibers. The matrix system is in many cases a thermosetting polymer, for example, a polyester resin, a vinyl ester resin, a polyurethane resin or an epoxy resin, or a thermoplastic polymer, for example, polyamide, polypropylene or polyethylene.

One advantage of fiber-reinforced plastics, especially, if glass fibers are used in combination with a suitable polymer matrix, is the high elongation at break and the elastic energy uptake. Due to their extremely low weight compared to other materials such as steel, glass fiber reinforced plastics are well suited in all areas where the overall weight is a relevant aspect. Most fiber reinforced polymers are also very suitable when in contact with an aggressive environment due to their excellent corrosion resistance. Furthermore, they display good mechanical properties together with a long service life. Thus, fiber reinforced plastics are also used for treatment, storage or transportation of diverse liquids, for example, for processing and cooling systems, for storage or transportation of waste water or in desalination plants. However, problems arise in cases where glass fiber reinforced plastics are in close contact with hot liquids, especially with hot aqueous media; it turned out that especially the polymer matrix is not durable in case of prolonged exposal to hot aqueous media.

The present invention has for its object to provide fiber reinforced plastics based on epoxy resins as matrix material that are chemically and physically stable even at exposure to hot liquid media for a prolonged period of time. The underlying curable composition shall further have advantageous properties when the fiber reinforced plastics are prepared according to a wrapping and/or winding method.

According to the present invention this object has been solved by a curable composition, which comprises an epoxy resin mixture, wherein the epoxy resin mixture comprises
a) an epoxy resin;
b) diethyl methyl benzene diamine (DETDA) as hardener;
c) at least one compound selected from the group consisting of 1,8-diazabicyclo[5.4.0]undec-7-ene (DBU) and 1,5-diazabicyclo[4.3.0]non-5-ene (DBN) as catalyst.

Surprisingly, it has been found that these curable compositions after curing, i.e. the composite elements prepared from these curable compositions, have good stability against damage caused by hot liquids, especially against hydrolysis caused by hot aqueous media. Said improved stability against damage, especially hydrolysis, is significantly reflected by good interlaminar shear strength results even after storage of test specimen in hot water for a prolonged period of time. The durability of a fiber reinforced plastic is largely dependent on the bonding between the reinforcing fiber and matrix material and on the matrix material's chemical and physical stability. The interlaminar shear strength (ILSS) of a fiber reinforced plastic, which is a characteristic parameter in determining durability, is influenced primarily by the interfacial bonding between the reinforcing fiber and the matrix material. For example, small changes in the surface of the fiber or in the matrix material can have a dramatic effect on ILSS. Thus, composite elements prepared from the curable compositions according to the present invention are well suited to be used for any kind of application which requires contact with hot liquids, especially with hot aqueous media.

According to the present invention, the catalyst according to c) is DBU or DBN or a mixture of DBU and DBN. In a preferred embodiment, the catalyst is DBU.

Generally, there are no specific restrictions regarding the type of epoxy resin, which is used according to a). Preferably, the epoxy resin according to a) comprises at least one epoxy resin selected from the group consisting of diglycidyl ether of bisphenol A, diglycidyl ether of bisphenol F, diglycidyl ether of hydrogenated bisphenol A, and diglycidyl ether of hydrogenated bisphenol F, more preferably at least one diglycidyl ether of bisphenol A. In a preferred embodiment, the diglycidyl ether of bisphenol A is a diglycidyl ether of bisphenol A having a viscosity at 25° C. in the range of from 6000 to 18000 mPa s determined according to DIN 53 015 and an Epoxy Equivalent Weight (EEW) in the range of from 174 to 198 g/eq determined according to DIN 16 945. In a further preferred embodiment, the diglycidyl ether of bisphenol A is a diglycidyl ether of bisphenol A having a viscosity at 25° C. in the range of from 10000 to 14000 mPa s determined according to DIN 53 015 and an EEW in the range of from 182-192 g/eq determined according to DIN 16 945 (Epilox A19-03).

One preferred embodiment relates to a curable composition, wherein the epoxy resin mixture comprises
a) a diglycidyl ether of bisphenol A having a viscosity at 25° C. in the range of from 6000 to 18000 mPa s determined according to DIN 53 015 and an EEW in the range of from 174 to 198 g/eq determined according to DIN 16 945;
b) diethyl methyl benzene diamine;
c) 1,8-diazabicyclo[5.4.0]undec-7-ene.

One further preferred embodiment relates to a curable composition, wherein the epoxy resin mixture comprises
a) a diglycidyl ether of bisphenol A having a viscosity at 25° C. in the range of from 10000 to 14000 mPa s determined according to DIN 53 015 and an EEW in the range of from 182 to 192 g/eq determined according to DIN 16 945 (Epilox A19-03);
b) diethyl methyl benzene diamine;
c) 1,8-diazabicyclo[5.4.0]undec-7-ene.

Generally, there are no specific restrictions regarding the amount of catalyst according to c), i.e. the amount of DBU or of DBN or of DBU and DBN, present in the curable composition. Preferably, the catalyst is present in an amount of from 0.1 to 20% by weight, preferably of from 0.3 to 5% by weight, relative to the amount of the epoxy resin.

Generally, there are no specific restrictions regarding the amount of hardener according to b), i.e. the amount of DETDA, present in the curable composition. Preferably, the hardener is present in an amount of from 1 to 35% by weight, preferably of from 5 to 30% by weight, more preferably of from 15 to 25% by weight, relative to the amount of the epoxy resin.

One preferred embodiment relates to a curable composition, wherein the epoxy resin mixture comprises
a) 100% by weight of a diglycidyl ether of bisphenol A having a viscosity at 25° C. in the range of from 6000 to 18000 mPa s determined according to DIN 53 015 and an EEW in the range of from 174 to 198 g/eq determined according to DIN 16 945 as epoxy resin;
b) diethyl methyl benzene diamine in an amount of from 15 to 25% by weight, relative to the amount of the epoxy resin;
c) 1,8-diazabicyclo[5.4.0]undec-7-ene in an amount of from 0.3 to 5% by weight, relative to the amount of the epoxy resin.

One further preferred embodiment relates to a curable composition, wherein the epoxy resin mixture comprises
a) 100% by weight of a diglycidyl ether of bisphenol A having a viscosity at 25° C. in the range of from 10000 to 14000 mPa s determined according to DIN 53 015 and an EEW in the range of from 182 to 192 g/eq determined according to DIN 16 945 as epoxy resin (Epilox A19-03);
b) diethyl methyl benzene diamine in an amount of from 15 to 25% by weight, relative to the amount of the epoxy resin;
c) 1,8-diazabicyclo[5.4.0]undec-7-ene in an amount of from 0.3 to 5% by weight, relative to the amount of the epoxy resin.

Generally, the epoxy resin mixture comprised in the curable composition can comprise further components in addition to a), b) and c). Preferably, the epoxy resin mixture comprises
d) at least one further diamine, preferably selected from the group consisting of cycloaliphatic diamines, meta-xylenediamine (MXDA) and meta-para-xylenediamine (MPXDA), more preferably selected from the group consisting of methyl cyclohexyl diamine (MCDA), isophorondiamine (IPDA), 4,4′-diamino dicyclohexyl methane (dicykan), 4,4′-methylene biscyclohexyl amine (PACM20), meta-xylenediamine (MXDA) and meta-para-xylenediamine (MPXDA).

Alternatively to d) or additionally to d), the epoxy resin mixture comprises at least one further component e) selected from the group consisting of pigments, dyes, tougheners, anti-foaming agents or flame-retarding agents.

Preferably, the curable composition consists of the epoxy resin mixture, which preferably consists of the components a), b) and c), more preferably of the components a), b), c) and d) or of the components a), b), c) and e). In one preferred embodiment, the curable composition consists of the epoxy resin mixture, which preferably consists of the components a), b), c), d) and e).

Preferably, the curable composition has an initial viscosity at 45° C. in the range of from 400 to 800 mPa s determined according to DIN 53 015. The measurement is done by a rheometer (Anton Parr). “Initial” in the context of the present invention means that the viscosity is measured as soon as the curable composition, which is preferably admixed at a temperature below 45° C., more preferably at a temperature in the range of from 5 to 35° C., more preferably at about 25° C., reaches the temperature of 45° C., wherein the increase in temperature is preferably caused by heating. The temperature measurement is also done by the rheometer. According to the present invention, all temperatures or temperature ranges indicated are related to an absolute pressure of 1 bar.

Preferably, the curable composition has a tₒₚₑₙ at 45° C., i.e. a time until the viscosity reaches the double initial viscosity, of 30 minutes or more, preferably in the range of from 40 to 150 minutes.

Preferably, the curable composition comprises reinforcing fibers embedded in the curable composition. Generally, there is no restriction regarding the material of the reinforcing fibers. Preferably, the reinforcing fibers are selected from the group consisting of glass fiber, carbon fiber, nylon fiber and aramid fiber, preferably glass fiber. Preferably, the reinforcing fibers are endless fibers, more preferably in the form of single fibers or rovings. Generally, there are no restrictions regarding the amount in which the reinforcing fibers are present in the curable composition. Preferably, the reinforcing fibers are present in an amount of from 10 to 80% by volume, preferably of from 25 to 75% by volume, more preferably of from 30 to 50% by volume, relative to the total volume of the curable composition.

### Process for Preparing the Curable Composition

The present invention is further directed to a process for preparing a curable composition, which comprises mixing of
a) an epoxy resin;
b) diethyl methyl benzene diamine (DETDA);
c) at least one compound selected from the group consisting of 1,8-diazabicyclo[5.4.0]undec-7-ene (DBU) and 1,5-diazabicyclo[4.3.0]non-5-ene (DBN).

Generally, no restriction exists regarding the type of epoxy resin. Preferred for the process, the epoxy resin according to a) comprises at least one epoxy resin selected from the group consisting of diglycidyl ether of bisphenol A, diglycidyl ether of bisphenol F, diglycidyl ether of hydrogenated bisphenol A, and diglycidyl ether of hydrogenated bisphenol F, more preferably at least one diglycidyl ether of bisphenol A. Preferably, the diglycidyl ether of bisphenol A is a diglycidyl ether of bisphenol A having a viscosity at 25° C. in the range of from 6000 to 18000 mPa s determined according to DIN 53 015 and an Epoxy Equivalent Weight (EEW) in the range of from 174 to 198 g/eq determined according to DIN 16 945. In a preferred embodiment, the diglycidyl ether of bisphenol A is a diglycidyl ether of bisphenol A having a viscosity at 25° C. in the range of from 10000 to 14000 mPa s determined according to DIN 53 015 and an EEW in the range of from 182 to 192 g/eq determined according to DIN 16 945 (Epilox A19-03).

The process for preparing the curable composition preferably comprises mixing of
a) a diglycidyl ether of bisphenol A having a viscosity at 25° C. in the range of from 6000 to 18000 mPa s determined according to DIN 53 015 and an EEW in the range of from 174 to 198 g/eq determined according to DIN 16 945;
b) diethyl methyl benzene diamine;
c) 1,8-diazabicyclo[5.4.0]undec-7-ene.

In a preferred embodiment, the process for preparing the curable composition preferably comprises mixing of
a) a diglycidyl ether of bisphenol A having a viscosity at 25° C. in the range of from 10000 to 14000 mPa s determined according to DIN 53 015 and an EEW in the range of from 182 to 192 g/eq determined according to DIN 16 945 (Epilox A19-03);
b) diethyl methyl benzene diamine;
c) 1,8-diazabicyclo[5.4.0]undec-7-ene.

Generally, no restrictions exist regarding the amount in which the catalyst according to c) is admixed. Preferably, the catalyst is admixed in an amount of from 0.1 to 20% by weight, preferably of from 0.3 to 5% by weight, relative to the amount of the epoxy resin. Generally, no restrictions exist regarding the amount in which the hardener according to b) is admixed. Preferably, the hardener is admixed in an amount of from 1 to 35% by weight, preferably of from 5 to 30% by weight, more preferably of from 15 to 25% by weight, relative to the amount of the epoxy resin.

In a preferred embodiment, the process for preparing the curable composition comprises mixing of
a) 100% by weight of a diglycidyl ether of bisphenol A having a viscosity at 25° C. in the range of from 6000 to 18000 mPa s determined according to DIN 53 015 and an EEW in the range of from 174 to 198 g/eq determined according to DIN 16 945 as epoxy resin;
b) diethyl methyl benzene diamine in an amount of from 15 to 25% by weight, relative to the amount of the epoxy resin;
c) 1,8-diazabicyclo[5.4.0]undec-7-ene in an amount of from 0.3 to 5% by weight, relative to the amount of the epoxy resin.

In a further preferred embodiment, the process for preparing the curable composition comprises mixing of
a) 100% by weight of a diglycidyl ether of bisphenol A having a viscosity at 25° C. in the range of from 10000 to 14000 mPa s determined according to DIN 53 015 and an EEW in the range of from 182 to 192 g/eq determined according to DIN 16 945 as epoxy resin;
b) diethyl methyl benzene diamine in an amount of from 15 to 25% by weight, relative to the amount of the epoxy resin;
c) 1,8-diazabicyclo[5.4.0]undec-7-ene in an amount of from 0.3 to 5% by weight, relative to the amount of the epoxy resin.

Generally, no restrictions exist regarding the admixing of further components in addition to a), b) and c). Preferably,
d) at least one further diamine, preferably selected from the group consisting of cycloaliphatic diamines, meta-xylenediamine (MXDA) and meta-para-xylenediamine (MPXDA), more preferably selected from the group consisting of methyl cyclohexyl diamine (MCDA), isophorondiamine (IPDA), 4,4′-diamino dicyclohexyl methane (dicykan), 4,4′-methylene biscyclohexyl amine (PACM20), meta-xylenediamine (MXDA) and meta-xylenediamine (MXDA) is admixed.

Alternatively to d) or in addition to d), at least one further component e) selected from the group consisting of pigments, dyes, tougheners, anti-foaming agents or flame-retarding agents is admixed.

Preferably, the process for preparing the curable composition consists of mixing of the components a), b) and c), more preferably of mixing of the components a), b), c) and d) or of the components a), b), c) and e). In one preferred embodiment, the process for preparing the curable composition consists of mixing of the components a), b), c), d) and e).

Preferably, the curable composition, prepared according to the process above, has an initial viscosity at 45° C. in the range of from 400 to 800 mPa s determined according to DIN 53 015. Also preferably, the time in which the viscosity of the curable composition reaches the double initial viscosity (tₒₚₑₙ) is 30 minutes or more, preferably in the range of from 40 to 150 minutes.

According to a preferred embodiment reinforcing fibers are added to the curable composition in the process described above. Generally, no restriction exists regarding the material of the reinforcing fibers. Preferably, the reinforcing fibers are selected from the group consisting of glass fiber, carbon fiber, nylon fiber and aramid fiber, preferably glass fiber. Preferably, the reinforcing fibers are endless fibers, preferably in the form of single fibers or rovings. In a preferred embodiment of the process, the reinforcing fibers are added in an amount of from 10 to 80% by volume, preferably of from 25 to 75% by volume, more preferably of from 30 to 50% by volume, relative to the total volume of the curable composition.

According to a further embodiment, the present invention is directed to a curable composition obtained or obtainable by the process for preparing a curable composition as disclosed above.

### Preparation of a Cured Epoxy Resin Mixture

Furthermore, the present invention is directed to a process for the preparation of a cured epoxy resin mixture, which comprises curing a curable composition as disclosed above, preferably by application of thermal energy (heating), more preferably by heating to a temperature above 60° C., more preferably to a temperature in the range of from 100 to 160° C. No restrictions exist regarding the atmosphere under which the curing is done. Preferably, the atmosphere is air.

Furthermore, the present invention is directed to a cured epoxy resin which is obtained or obtainable by the process for the preparation of a cured epoxy resin mixture as disclosed above.

### Composite Elements

According to a further embodiment, the present invention is directed to a process for the preparation of composite elements, which comprises
i) providing reinforcing fibers;
ii) impregnating the reinforcing fibers according to i) with a curable composition comprising an epoxy resin mixture, wherein the epoxy resin mixture comprises
   a) an epoxy resin;
   b) diethyl methyl benzene diamine (DETDA) as hardener;
   c) at least one compound selected from the group consisting of 1,8-diazabicyclo[5.4.0]undec-7-ene (DBU) and 1,5-diazabicyclo[4.3.0]non-5-ene (DBN) as catalyst;
in order to obtain reinforcing fibers impregnated with the curable composition;
iii) applying the reinforcing fibers impregnated with the curable composition according to ii) to a surface of a support element obtaining a support element having reinforcing fibers impregnated with the curable composition on its surface;
iv) curing the curable composition obtaining the composite element;
v) optionally removing the support element.

As discussed above, it has been surprisingly found that the composite elements prepared from the curable compositions as disclosed above, have good stability against damage caused by hot liquids, especially against hydrolysis caused by hot aqueous media. Said improved stability against damage, especially hydrolysis, is significantly reflected by good interlaminar shear strength results even after storage of test specimen in hot water for a prolonged period of time. The durability of a fiber reinforced plastic is largely dependent on the bonding between the reinforcing fiber and matrix material and on chemical and physical stability. The interlaminar shear strength (ILSS) of a fiber reinforced plastic, which is a characteristic parameter in determining durability, is influenced primarily by the interfacial bonding between the reinforcing fiber and the matrix material. For example, small changes in the surface of the fiber or in the matrix material can have a dramatic effect on ILSS. Thus, composite elements prepared from the curable compositions according to the present invention are well suited to be used for any kind of application which requires contact with hot liquids, especially with hot aqueous media.

Generally, forming of composite elements (fiber reinforced plastics) can be done by several methods such as molding, wrapping or winding. According to the present invention, the preferred forming methods are wrapping and winding, more preferred is filament winding. In a preferred embodiment of the process for the preparation of composite elements, the support element according to iii) has a diameter, a longitudinal extension vertically to the diameter and an outer surface parallel to the longitudinal extension and wherein applying the reinforcing fibers in iii) is done by winding the reinforcing fibers impregnated with the curable composition around the support element's outer surface. The support element having a diameter, a longitudinal extension vertically to the diameter and an outer surface parallel to the longitudinal extension is preferably a cylinder, which functions as mandrel. Fibers or fiber bundles are pulled through a wet bath containing the curable composition as disclosed above and wound over the rotating mandrel in specific orientations. After curing the mandrel can be removed, leaving a final geometric shape but can be left in some cases.

The curing according to iv) can be done by any suitable method. Preferably, curing is done by application of thermal energy (heating), more preferably by heating to a temperature above 60° C. and keeping this temperature for at least one hour. More preferably, curing is done by heating to a temperature in the range of from 100 to 180° C. and keeping this temperature for at least 0.5 h, more preferably by heating to a temperature in the range of from 120 to 170° C. and keeping this temperature for a time in the range of from 2 to 10 h, more preferably heating to a temperature in the range of from 130 to 160° C. and keeping this temperature for a time in the range of from 2 to 6 h. No restrictions exist regarding the atmosphere under which the curing is done. Preferably, the atmosphere is air.

Preferably, a pre-curing step is applied before the curing step iv), wherein said pre-curing step comprises heating to a temperature in the range of from 60 to 100° C. and keeping this temperature for at least 0.5 h, more preferably heating to a temperature in the range of from 70 to 90° C. and keeping this temperature for a time in the range of from 0.5 to 10 h, more preferably heating to a temperature in the range of from 75 to 85° C. and keeping this temperature for a time in the range of from 1.5 to 3 h.

According to the present invention, the process comprises the steps (i), (ii), (iii), and (iv), preferably (i), (ii), (iii), (iv) and (v), more preferably (i), (ii), (iii), (iv), the pre-curing and (v). In one embodiment, the process consists of the steps (i), (ii), (iii) and (iv), preferably of the steps (i), (ii), (iii), (iv) and (v), more preferably of (i), (ii), (iii), (iv), the pre-curing and (v).

Generally, no restriction exists regarding the type of the epoxy resin. Preferably, the epoxy resin according to a) comprises at least one epoxy resin selected from the group consisting of diglycidyl ether of bisphenol A, diglycidyl ether of bisphenol F, diglycidyl ether of hydrogenated bisphenol A, and diglycidyl ether of hydrogenated bisphenol F, preferably at least one diglycidyl ether of bisphenol A. In a preferred embodiment, the diglycidyl ether of bisphenol A is a diglycidyl ether of bisphenol A having a viscosity at 25° C. in the range of from 6000 to 18000 mPa s determined according to DIN 53 015 and an Epoxy Equivalent Weight (EEW) in the range of from 174 to 198 g/eq determined according to DIN 16 945. In a further preferred embodiment, the diglycidyl ether of bisphenol A is a diglycidyl ether of bisphenol A having a viscosity at 25° C. in the range of from 10000 to 14000 mPa s determined according to DIN 53 015 and an EEW in the range of from 182 to 192 g/eq determined according to DIN 16 945 (Epilox A19-03).

In one preferred embodiment of the process for preparing the composite element, the epoxy resin mixture comprises
a) a diglycidyl ether of bisphenol A having a viscosity at 25° C. in the range of from 6000 to 18000 mPa s determined according to DIN 53 015 and an EEW in the range of from 174 to 198 g/eq determined according to DIN 16 945;
b) diethyl methyl benzene diamine;
c) 1,8-diazabicyclo[5.4.0]undec-7-ene.

In a further preferred embodiment of the process for preparing the composite element, the epoxy resin mixture comprises
a) a diglycidyl ether of bisphenol A having a viscosity at 25° C. in the range of from 10000 to 14000 mPa s determined according to DIN 53 015 and an EEW in the range of from 182 to 192 g/eq determined according to DIN 16 945 (Epilox A19-03);
b) diethyl methyl benzene diamine;
c) 1,8-diazabicyclo[5.4.0]undec-7-ene.

Preferably, the catalyst c) is present in the curable composition according to ii) in an amount of from 0.1 to 20% by weight, more preferably of from 0.3 to 5% by weight, relative to the amount of the epoxy resin. The hardener b) is preferably present in the curable composition according to ii) in an amount of from 1 to 35% by weight, more preferably of from 5 to 30% by weight, more preferably of from 15 to 25% by weight, relative to the amount of the epoxy resin.

In a preferred embodiment of the process for the preparation of the composite element, the epoxy resin mixture comprises
a) 100% by weight of a diglycidyl ether of bisphenol A having a viscosity at 25° C. in the range of from 6000 to 18000 mPa s determined according to DIN 53 015 and an EEW in the range of from 174 to 198 g/eq determined according to DIN 16 945 as epoxy resin;
b) diethyl methyl benzene diamine in an amount of from 15 to 25% by weight, relative to the amount of the epoxy resin;
c) 1,8-diazabicyclo[5.4.0]undec-7-ene in an amount of from 0.3 to 5% by weight, relative to the amount of the epoxy resin.

In a further preferred embodiment of the process for the preparation of the composite element, the epoxy resin mixture comprises
a) 100% by weight of a diglycidyl ether of bisphenol A having a viscosity at 25° C. in the range of from 10000 to 14000 mPa s determined according to DIN 53 015 and an EEW in the range of from 182 to 192 g/eq determined according to DIN 16 945 as epoxy resin (Epilox A19-03);
b) diethyl methyl benzene diamine in an amount of from 15 to 25% by weight, relative to the amount of the epoxy resin;
c) 1,8-diazabicyclo[5.4.0]undec-7-ene in an amount of from 0.3 to 5% by weight, relative to the amount of the epoxy resin.

Preferably, the epoxy resin mixture comprised in the curable composition according to ii) comprises in addition to a), b) and c)
d) at least one further diamine, preferably selected from the group consisting of cycloaliphatic diamines, meta-xylenediamine (MXDA) and meta-xylenediamine (MXDA), more preferably selected from the group consisting of methyl cyclohexyl diamine (MCDA), isophorondiamine (IPDA) 4,4′-diamino dicyclohexyl methane (dicykan), 4,4′-methylene biscyclohexyl amine (PACM20), meta-xylenediamine (MXDA) and meta-xylenediamine (MXDA).

Alternatively to d) or in addition to d), the epoxy resin mixture can comprise at least one further component e) selected from the group consisting of pigments, dyes, tougheners, anti-foaming agents or flame-retarding agents.
Preferably, the curable composition according to ii) consist of the epoxy resin mixture, which preferably consists of the components a), b) and c), more preferably of the components a), b), c) and d) or of the components a), b), c) and e), more preferably of the components a), b), c), d) and e).

Preferably, the curable composition according to ii) has an initial viscosity at 45° C. in the range of from 400 to 800 mPa s determined according to DIN 53 015. Preferably, the time in which the viscosity of the curable composition according to ii) reaches the double initial viscosity (tₒₚₑₙ) is 30 minutes or more, preferably in the range of from 40 to 150 minutes.

Generally, no restrictions exist regarding the material of the reinforcing fibers. Preferably, the reinforcing fibers are selected from the group consisting of glass fiber, carbon fiber, nylon fiber and aramid fiber, preferably glass fiber. Preferably, the reinforcing fibers are endless fibers, more preferably in the form of single fibers or rovings. Generally, no restrictions exist regarding the amount in which the reinforcing fibers are present in the composite element. Preferably, the reinforcing fibers are present in an amount of from 10 to 80% by volume, preferably of from 25 to 75% by volume, more preferably of from 30 to 50% by volume, relative to the total volume of the curable composition.

Furthermore, the present invention is directed to a composite element which is obtained or obtainable by a process for the preparation of a composite element as disclosed above.

### Use of the Composite Elements

The present invention is furthermore directed to the use of a composite element prepared according to the process for the preparation of a composite element as disclosed above for pipes, tubes or vessels, preferably for pipes, tubes or vessels which are used for transportation or storage of liquid media, more preferably for pipes, tubes or vessels which are used for transportation or storage of hot liquid media. The invention is also directed to a method for transporting or storing liquid media, preferably hot liquid media, wherein the pipes, tubes or vessels used for transportation or storage or for transportation and storage comprise the composite element prepared according to the process for the preparation of a composite element as disclosed above. Preferably, the liquid media are aqueous media, preferably aqueous media comprising water in a content of at least 10% by weight, preferably in the range of from 10 to 100% by weight, more preferably in the range of from 50% by weight to 100% by weight. In the context of the present invention “hot” refers to a temperature of at least 30° C., preferably at least 50° C., more preferably at least 80° C., more preferably in the range of from 80 to <100° C., at an absolute pressure of 1 bar.

The present invention is further illustrated by the following set of embodiments and combinations of embodiments resulting from the given dependencies and back-references.
1. A curable composition, which comprises an epoxy resin mixture, wherein the epoxy resin mixture comprises
   a) an epoxy resin;
   b) diethyl methyl benzene diamine (DETDA) as hardener;
   c) at least one compound selected from the group consisting of 1,8-diazabicyclo[5.4.0]undec-7-ene (DBU) and 1,5-diazabicyclo[4.3.0]non-5-ene (DBN) as catalyst.
2. The curable composition according to embodiment 1, wherein the epoxy resin according to a) comprises at least one epoxy resin selected from the group consisting of diglycidyl ether of bisphenol A, diglycidyl ether of bisphenol F, diglycidyl ether of hydrogenated bisphenol A, and diglycidyl ether of hydrogenated bisphenol F, preferably at least one diglycidyl ether of bisphenol A.
3. The curable composition according to embodiment 2, wherein the diglycidyl ether of bisphenol A is a diglycidyl ether of bisphenol A having a viscosity at 25° C. in the range of from 6000 to 18000 mPa s determined according to DIN 53 015 and an Epoxy Equivalent Weight (EEW) in the range of from 174 to 198 g/eq determined according to DIN 16 945 (Epilox A19-03).
4. The curable composition according to any one of embodiments 1 to 3, wherein the epoxy resin mixture comprises
   a) a diglycidyl ether of bisphenol A having a viscosity at 25° C. in the range of from 6000 to 18000 mPa s determined according to DIN 53 015 and an EEW in the range of from 174 to 198 g/eq determined according to DIN 16 945;
   b) diethyl methyl benzene diamine;
   c) 1,8-diazabicyclo[5.4.0]undec-7-ene.
5. The curable composition according to any one of embodiments 1 to 4, wherein the catalyst according to c) is present in an amount of from 0.1 to 20% by weight, preferably of from 0.3 to 5% by weight, relative to the amount of the epoxy resin.
6. The curable composition according to any one of embodiments 1 to 5, wherein the hardener according to b) is present in an amount of from 1 to 35% by weight, preferably of from 5 to 30% by weight, more preferably of from 15 to 25% by weight, relative to the amount of the epoxy resin.
7. The curable composition according to any one of embodiments 1 to 6, wherein the epoxy resin mixture comprises
   a) 100% by weight of a diglycidyl ether of bisphenol A having a viscosity at 25° C. in the range of from 6000 to 18000 mPa s determined according to DIN 53 015 and an EEW in the range of from 174 to 198 g/eq determined according to DIN 16 945 as epoxy resin;
   b) diethyl methyl benzene diamine in an amount of from 15 to 25% by weight, relative to the amount of the epoxy resin; 1,8-diazabicyclo[5.4.0]undec-7-ene in an amount of from 0.3 to 5% by weight, relative to the amount of the epoxy resin.
8. The curable composition according to any one of embodiments 1 to 7, wherein the epoxy resin mixture comprises
   d) at least one further diamine, preferably selected from the group consisting of cycloaliphatic diamines, meta-xylenediamine (MXDA) and meta-para-xylenediamine (MPXDA), more preferably selected from the group consisting of methyl cyclohexyl diamine (MCDA) isophorondiamine (IPDA), 4,4′-diamino dicyclohexyl methane (dicykan), 4,4′-methylene biscyclohexyl amine (PACM20), meta-xylenediamine (MXDA) and meta-para-xylenediamine (MPXDA).
9. The curable composition according to any one of embodiments 1 to 8, wherein the epoxy resin mixture comprises at least one further component e) selected from the group consisting of pigments, dyes, tougheners, anti-foaming agents or flame-retarding agents.
10. The curable composition according to any one of embodiments 1 to 9, which has an initial viscosity at 45° C. in the range of from 400 to 800 mPa s determined according to DIN 53 015.
11. The curable composition according to any one of embodiments 1 to 10, wherein the time in which the viscosity reaches the double initial viscosity (tₒₚₑₙ) is 30 minutes or more, preferably in the range of from 40 to 150 minutes.
12. The curable composition according to any one of embodiments 1 to 11, comprising reinforcing fibers embedded in the curable composition.
13. The curable composition according to embodiment 12, wherein the reinforcing fibers are selected from the group consisting of glass fiber, carbon fiber, nylon fiber and aramid fiber, preferably glass fiber.
14. The curable composition according to embodiment 12 or 13, wherein the reinforcing fibers are endless fibers, preferably in the form of single fibers or rovings.
15. The curable composition according to any one of embodiments 12 to 14, wherein the reinforcing fibers are present in an amount of from 10 to 80% by volume, preferably of from 25 to 75% by volume, more preferably of from 30 to 50% by volume, relative to the total volume of the curable composition.
16. A process for preparing a curable composition, which comprises mixing of
   a) an epoxy resin;
   b) diethyl methyl benzene diamine (DETDA);
   c) at least one compound selected from the group consisting of 1,8-diazabicyclo[5.4.0]undec-7-ene (DBU) and 1,5-diazabicyclo[4.3.0]non-5-ene (DBN).
17. The process according to embodiment 16, wherein the epoxy resin according to a) comprises at least one epoxy resin selected from the group consisting of diglycidyl ether of bisphenol A, diglycidyl ether of bisphenol F, diglycidyl ether of hydrogenated bisphenol A, and diglycidyl ether of hydrogenated bisphenol F, preferably at least one diglycidyl ether of bisphenol A.
18. The process according to embodiment 17, wherein the diglycidyl ether of bisphenol A is a diglycidyl ether of bisphenol A having a viscosity at 25° C. in the range of from 6000 to 18000 mPa s determined according to DIN 53 015 and an Epoxy Equivalent Weight (EEW) in the range of from 174 to 198 g/eq determined according to DIN 16 945 (Epilox A19-03).
19. The process according to any one of embodiments 16 to 18, which comprises mixing of
   a) a diglycidyl ether of bisphenol A having a viscosity at 25° C. in the range of from 6000 to 18000 mPa s determined according to DIN 53 015 and an EEW in the range of from 174 to 198 g/eq determined according to DIN 16 945;
   b) diethyl methyl benzene diamine;
   c) 1,8-diazabicyclo[5.4.0]undec-7-ene.
20. The process according to any one of embodiments 16 to 19, wherein the catalyst according to c) is admixed in an amount of from 0.1 to 20% by weight, preferably of from 0.3 to 5% by weight, relative to the amount of the epoxy resin.
21. The process according to any one of embodiments 16 to 20, wherein the hardener according to b) is admixed in an amount of from 1 to 35% by weight, preferably of from 5 to 30% by weight, more preferably of from 15 to 25% by weight, relative to the amount of the epoxy resin.
22. The process according to any one of embodiments 16 to 21, which comprises mixing of
   a) 100% by weight of a diglycidyl ether of bisphenol A having a viscosity at 25° C. in the range of from 6000 to 18000 mPa s determined according to DIN 53 015 and an EEW in the range of from 174 to 198 g/eq determined according to DIN 16 945 as epoxy resin;
   b) diethyl methyl benzene diamine in an amount of from 15 to 25% by weight, relative to the amount of the epoxy resin;
   a) 1,8-diazabicyclo[5.4.0]undec-7-ene in an amount of from 0.3 to 5% by weight, relative to the amount of the epoxy resin.
23. The process according to any one of embodiments 16 to 22, which comprises admixing of
   d) at least one further diamine, preferably selected from the group consisting of cycloaliphatic diamines, meta-xylenediamine (MXDA) and meta-xylenediamine (MXDA), more preferably selected from the group consisting of methyl cyclohexyl diamine (MCDA), isophorondiamine (IPDA) 4,4′-diamino dicyclohexyl methane (dicykan), 4,4′-methylene biscyclohexyl amine (PACM20), meta-xylenediamine (MXDA) and meta-xylenediamine (MXDA).
24. The process according to any one of embodiments 16 to 23, which comprises admixing of at least one further component e) selected from the group consisting of pigments, dyes, tougheners, anti-foaming agents or flame-retarding agents.
25. The process according to any one of embodiments 16 to 24, wherein the curable composition has an initial viscosity at 45° C. in the range of from 400 to 800 mPa s determined according to DIN 53 015.
26. The process according to any one of embodiments 16 to 26, wherein the time in which the viscosity of the curable composition reaches the double initial viscosity (tₒₚₑₙ) is 30 minutes or more, preferably in the range of from 40 to 150 minutes.
27. The process according to any one of embodiments 16 to 26, comprising adding reinforcing fibers to the curable composition.
28. The process according to embodiment 27, wherein the
reinforcing fibers are selected from the group consisting of glass fiber, carbon fiber, nylon fiber and aramid fiber, preferably glass fiber.
29. The process according to embodiment 27 or 28, wherein the reinforcing fibers are endless fibers, preferably in the form of single fibers or rovings.
30. The process according to any one of embodiments 27 to 29, wherein the reinforcing fibers are added in an amount of from 10 to 80% by volume, preferably of from 25 to 75% by volume, more preferably of from 30 to 50% by volume, relative to the total volume of the curable composition.
31. A curable composition obtained or obtainable by the process of any one of embodiments 26 to 30.
32. A process for the preparation of a cured epoxy resin mixture, which comprises curing a curable composition according to any one of embodiments 1 to 15 or according to embodiment 31, preferably by application of thermal energy (heating), more preferably by heating to a temperature above 60° C., more preferably to a temperature in the range of from 100 to 160° C.
33. A cured epoxy resin which is obtained or obtainable by a process according to embodiment 32.
34. A process for the preparation of composite elements, which comprises
   i) providing reinforcing fibers;
   ii) impregnating the reinforcing fibers according to i) with a curable composition comprising an epoxy resin mixture, wherein the epoxy resin mixture comprises
      a) an epoxy resin;
      b) diethyl methyl benzene diamine (DETDA) as hardener;
      c) at least one compound selected from the group consisting of 1,8-diazabicyclo[5.4.0]undec-7-ene (DBU) and 1,5-diazabicyclo[4.3.0]non-5-ene (DBN) as catalyst;
   in order to obtain reinforcing fibers impregnated with the curable composition;
   iii) applying the reinforcing fibers impregnated with the curable composition according to ii) to a surface of a support element obtaining a support element having reinforcing fibers impregnated with the curable composition on its surface;
   vi) curing the curable composition;
   vii) optionally removing the support element.
35. The process according to embodiment 34, wherein the support element according to iii) has a diameter, a longitudinal extension vertically to the diameter and an outer surface parallel to the longitudinal extension and wherein applying the reinforcing fibers in iii) is done by winding the reinforcing fibers impregnated with the curable composition around the support element's outer surface.
36. The process according to embodiment 34 or 35, which comprises the steps (i), (ii), (iii), (iv) and (v).
37. The process according to any one of embodiments 34 to 36, which consists of the steps (i), (ii), (iii) and (iv), preferably of the steps (i), (ii), (iii), (iv) and (v).
38. The process according to any one of embodiments 34 to 37, wherein the epoxy resin according to a) comprises at least one epoxy resin selected from the group consisting of diglycidyl ether of bisphenol A, diglycidyl ether of bisphenol F, diglycidyl ether of hydrogenated bisphenol A, and diglycidyl ether of hydrogenated bisphenol F, preferably at least one diglycidyl ether of bisphenol A.
39. The process according to embodiment 38, wherein the diglycidyl ether of bisphenol A is a diglycidyl ether of bisphenol A having a viscosity at 25° C. in the range of from 6000 to 18000 mPa s determined according to DIN 53 015 and an Epoxy Equivalent Weight (EEW) in the range of from 174 to 198 g/eq determined according to DIN 16 945 (Epilox A19-03).
40. The process according to any one of embodiments 34 to 39, wherein the epoxy resin mixture comprises
   a) a diglycidyl ether of bisphenol A having a viscosity at 25° C. in the range of from 6000 to 18000 mPa s determined according to DIN 53 015 and an EEW in the range of from 174 to 198 g/eq determined according to DIN 16 945;
   b) diethyl methyl benzene diamine;
   c) 1,8-diazabicyclo[5.4.0]undec-7-ene.
41. The process according to any one of embodiments 34 to 40, wherein the catalyst according to c) is present in an amount of from 0.1 to 20% by weight, preferably of from 0.3 to 5% by weight, relative to the amount of the epoxy resin.
42. The process according to any one of embodiments 34 to 41, wherein the hardener according to b) is present in an amount of from 1 to 35% by weight, preferably of from 5 to 30% by weight, more preferably of from 15 to 25% by weight, relative to the amount of the epoxy resin.
43. The process according to any one of embodiments 34 to 42, wherein the epoxy resin mixture comprises
   a) 100% by weight of a diglycidyl ether of bisphenol A having a viscosity at 25° C. in the range of from 6000 to 18000 mPa s determined according to DIN 53 015 and an EEW in the range of from 174 to 198 g/eq determined according to DIN 16 945 as epoxy resin;
   b) diethyl methyl benzene diamine in an amount of from 15 to 25% by weight, relative to the amount of the epoxy resin;
   d) 1,8-diazabicyclo[5.4.0]undec-7-ene in an amount of from 0.3 to 5% by weight, relative to the amount of the epoxy resin.
44. The process according to any one of embodiments 34 to 43, wherein the epoxy resin mixture comprises
   d) at least one further diamine, preferably selected from the group consisting of cycloaliphatic diamines, meta-xylenediamine (MXDA) and meta-para-xylenediamine (MPXDA), more preferably selected from the group consisting of methyl cyclohexyl diamine (MCDA), isophorondiamine (IPDA), 4,4′-diamino dicyclohexyl methane (dicykan), 4,4′-methylene biscyclohexyl amine (PACM20), meta-xylenediamine (MXDA) and meta-para-xylenediamine (MPXDA).
45. The process according to any one of embodiments 34 to 44, wherein the epoxy resin mixture comprises at least one further component e) selected from the group consisting of pigments, dyes, tougheners, anti-foaming agents or flame-retarding agents.
46. The process according to any one of embodiments 34 to 45, wherein the curable composition has an initial viscosity at 45° C. in the range of from 400 to 800 mPa s determined according to DIN 53 015.
47. The process according to any one of embodiments 34 to 46, wherein the time in which the viscosity of the curable composition reaches the double initial viscosity (tₒₚₑₙ) is 30 minutes or more, preferably in the range of from 40 to 150 minutes.
48. The process according to any one of embodiments 34 to 47, wherein the
reinforcing fibers are selected from the group consisting of glass fiber, carbon fiber, nylon fiber and aramid fiber, preferably glass fiber.
49. The process according to any one of embodiments 34 to 48, wherein the reinforcing fibers are endless fibers, preferably in the form of single fibers or rovings.
50. The process according to any one of embodiments 34 to 49, wherein the reinforcing fibers are present in an amount of from 10 to 80% by volume, preferably of from 25 to 75% by volume, more preferably of from 30 to 50% by volume, relative to the total volume of the curable composition.
51. A composite element which is obtained or obtainable by a process according to any one of embodiments 34 to 50.
52. Use of the composite element prepared according to the process of any one of embodiments 34 to 50 or of the composite element of embodiment 51 for pipes, tubes or vessels, preferably for pipes, tubes or vessels which are used for transportation or storage of liquid media, more preferably for pipes, tubes or vessels which are used for transportation or storage of hot liquid media.
53. The use according to embodiment 52, wherein the liquid media are aqueous media, preferably aqueous media comprising water in a content of at least 10% by weight, preferably in the range of from 10 to 100% by weight, more preferably in the range of from 50% by weight to 100% by weight.

### EXAMPLES

### Chemicals

Epilox A19-03: diglycidyl ether of bisphenol A having a viscosity at 25° C. in the range of from 10000 to 14000 mPa s determined according to DIN 53 015 and an EEW in the range of from 182 to 192 g/eq determined according to DIN 16 945
DETDA: diethyl methyl benzene diamine
MCDA: methyl cyclohexyl diamine
IPDA: isophorondiamine
DBU: 1,8-diazabicyclo[5.4.0]undec-7-ene
TMG: tetramethylguanidine
EMIM-DCA: 1-ethyl-3-methyl-imidazolium dicyanamide
DABCO: 1,4-diazabicyclo[2.2.2]octane
Dicykan: 4,4′-diaminodicyclohexylmethane

### Reference Example 1—Characterisation of Resin Properties

The individual components were mixed in the ratios indicated in table 1.

The following parameters were determined on a rheometer (Anton Parr):
initial viscosity at 45° C. (ηstart)
time until a doubling of the initial viscosity at 45° C. is reached
time until the maximum modulus of loss G″ at 145° C. is reached.

The following parameters were determined by differential scanning calorimetry (DSC) (TA instruments DSC Q 2000):
Onset' temperature
Enthalpy
Glass transition temperature Tg after 5 h at 145° C.

TABLE 1

| | | Parts | Hardener | | Diamine | Parts | | | Parts |
|---|---|---|---|---|---|---|---|---|---|
| | | per | (amine | | (amine | per | Aminic | | per |
| experiment | resin | weight | 1) | parts | 2) | weight | curing | catalyst | weight |
| 1 | Epilox | 100 | DETDA | 24 | — | 0 | 100% | — | 0 |
| (comparative) | A19-03 | | | | | | | | |
| 2 | Epilox | 100 | DETDA | 24 | — | 0 | 100% | DBU | 2 |
| | A19-03 | | | | | | | | |
| 3 | Epilox | 100 | DETDA | 19.8 | MCDA | 3.2 | 100% | DBU | 2 |
| | A19-03 | | | | | | | | |
| 4 | Epilox | 100 | DETDA | 20 | IPDA | 4 | 100% | DBU | 2 |
| | A19-03 | | | | | | | | |
| 5 | Epilox | 100 | DETDA | 9.1 | IPDA | 8.6 | 75% | TMG | 1.3 |
| (comparative) | A19-03 | | | | | | | | |
| 6 | Epilox | 100 | DETDA | 8 | MCDA | 6 | 70% | EMIM- | 1.0 |
| (comparative) | A19-03 | | | | | | | DCA | |
| 7 | Epilox | 100 | DETDA | 8 | MCDA | 9.5 | 75% | DABCO | 1.5 |
| (comparative) | A19-03 | | | | | | | | |
| 8 | Epilox | 100 | DETDA | 9.7 | MCDA | 10 | 100% | DBU | 1.3 |
| | A19-03 | | | | | | | | |
| 9 | Epilox | 100 | DETDA | 7.3 | MCDA | 7.7 | 75% | DBU | 2 |
| | A19-03 | | | | | | | | |
| 10 | Epilox | 100 | DETDA | 15.6 | Dicykan | 10.4 | 100% | — | 0 |
| (comparative) | A19-03 | | | | | | | | |

| | initial | | | | | |
|---|---|---|---|---|---|---|
| | viscosity | | Time until | | | |
| | ηstart | tₒₚₑₙ | max. modulus | Onset | | Tg after 5 h |
| | [mPa*s] | [min] | of loss at | temperature | Enthalpy | at 145° C. |
| Experiment no. | at 45° C. | at 45° C. | 145° C. [min] | [° C.] | [J/g] | [° C.] |
| 1 (comparative) | 640 | >300 | 164 | 121 | 240 | 160 |
| 2 | 653 | 107 | 93 | 85.6 | 248 | 161 |
| 3 | 606 | 53 | 73 | 77.4 | 306 | 157 |
| 4 | 670 | 43 | 76 | 59 | 105 | 160 |
| 5 (comparative) | 580 | 31 | 61* | 54.1 | 386 | 124 |
| 6 (comparative) | 620 | 33 | 24 | 59/123 | 166 | 152 |
| 7 (comparative) | 530 | 11 | 102 | 63 | 310 | 116 |
| 8 | 400 | 28 | 38 | 59 | 324 | 156 |
| 9 | 543 | 31 | 46 | 56 | 242 | 118 |
| 10 (comparative) | 659 | 29 | 76 | 50 | 279 | 163 |

”—”not present
”Aminic curing“percentage of epoxy groups contained in the resin, which can react with the amino groups of all amines present in the curable composition, i.e. the amino groups of amine 1 and amine 2.
”xxx”not determined
*determined at 120° C. instead of 145° C.

### Example 1—Preparation and Characterisation of Glass Fiber Laminates

The individual components were mixed in the ratios as indicated in table 2 in order to obtain epoxy resin mixtures. Afterwards, glass fibers were impregnated with the epoxy resin mixtures in fiber direction 0/90° resulting in laminates with a fiber volume content of about 40%. Curing was done as indicated in Table 2. The fiber-matrix-adhesion of the cured composite elements (plates) was determined in dry state by interlaminar shear strength (ILSS) experiment according to ASTM D2344. Therein, the force necessary for delamination is determined both in warp and in weft direction. 50% of the test specimen was stored for 14 days in water having a temperature of 95° C. Afterwards, these test specimen were measured in warp and in weft direction in wet stage. The results are indicated in table 2.

TABLE 2

| | | Parts | Hardener | Parts | Diamine | Parts | | Parts | | |
|---|---|---|---|---|---|---|---|---|---|---|
| | | per | (diamine | per | (diamine | per | | per | Curing | Aminic |
| plate | resin | weight | a) | weight | b) | weight | catalyst | weight | conditions | curing |
| 2 | Epilox | 100 | DETDA | 24 | — | 0 | DBU | 2 | 2 h 80° C. + | 100% |
| | A19-03 | | | | | | | | 5 h 145° C. | |
| 3 | Epilox | 100 | DETDA | 19.8 | MCDA | 3.2 | DBU | 2 | 2 h 80° C. + | 100% |
| | A19-03 | | | | | | | | 5 h 145° C. | |
| 4 | Epilox | 100 | DETDA | 20 | IPDA | 4 | DBU | 2 | 2 h 80° C. + | 100% |
| | A19-03 | | | | | | | | 5 h 145° C. | |
| 5 | Epilox | 100 | DETDA | 9.1 | IPDA | 8.6 | TMG | 1.3 | 2 h 80° C. + | 75% |
| (comparative) | A19-03 | | | | | | | | 5 h 125° C. | |
| 6 | Epilox | 100 | DETDA | 8 | MCDA | 6 | EMIM- | 1.0 | 5 h 145° C. | 70% |
| (comparative) | A19-03 | | | | | | DCA | | | |
| 7 | Epilox | 100 | DETDA | 8 | MCDA | 9.5 | DABCO | 1.5 | 2 h 80° C. + | 75% |
| (comparative) | A19-03 | | | | | | | | 5 h 145° C. | |
| 8 | Epilox | 100 | DETDA | 9.7 | MCDA | 10 | DBU | 1.3 | 2 h 80° C. + | 100% |
| | A19-03 | | | | | | | | 5 h 145° C. | |
| 9 | Epilox | 100 | DETDA | 7.3 | MCDA | 7.7 | DBU | 2 | 2 h 80° C. + | 75% |
| | A19-03 | | | | | | | | 5 h 145° C. | |
| 10 | Epilox | 100 | DETDA | 15.6 | Dicykan | 10.4 | — | 0 | 2 h 80° C. + | 100% |
| (comparative) | A19-03 | | | | | | | | 5 h 145° C. | |

| | | ILSS dry | | | |
|---|---|---|---|---|---|
| | | warp | | | |
| | | Mean | ILSS dry weft | ILSS wet warp | ILSS wet weft |
| | | value | Mean value | Mean value | Mean value |
| plate | Tg [° C.] | [N/mm²] | [N/mm²] | [N/mm²] | [N/mm²] |
| 2 | 141 | 54.59 | 51.40 | 44.90 | 41.19 |
| 3 | 163 | 54.38 | 50.52 | 42.20 | 41.30 |
| 4 | 157 | 54.50 | 54.26 | 46.79 | 40.55 |
| 5 (comparative) | 128 | 54.68 | 49.34 | 33.78 | 29.68 |
| 6 (comparative) | 157 | 44.26 | 40.21 | 40.83 | 36.03 |
| 7 (comparative) | 121 | 49.65 | 45.88 | 42.22 | 36.35 |
| 8 | 161 | 58.31 | 51.21 | 51.28 | 46.26 |
| 9 | 120 | 58.67 | 52.80 | 50.53 | 46.01 |
| 10 (comparative) | 165 | 51.54 | 40.70 | 42.88 | 36.91 |

”—”not present
”Aminic curing“percentage of epoxy groups contained in the resin, which can react with the amino groups of all amines present in the curable composition, i.e. the amino groups of amine 1 and amine 2.

As apparent from the results shown in Tables 1 and 2, DETDA offered a very suitable tₒₚₑₙ (>300 min) but required much time for curing. Mixing of DETDA with other cycloaliphatic amines reduced the curing time but also reduced tₒₚₑₙ, i.e. the time left for processing. The addition of catalysts also accelerated the curing, wherein only the combination of DETDA with DBU still gave suitable tₒₚₑₙ values in the range of from 28 to 107 minutes. The ILSS measurements in dry state resulted in comparable results at least for the combinations of DETDA with DBU and of DETDA with TMG; already the combinations of DETDA with EMIM-DCA and of DETDA with DABCO gave poorer results. However, it was surprisingly found that only the combination of DETDA with DBU still resulted in good ILSS values after storage in hot water, i.e. only the laminates with DETDA and DBU showed a good resistance to hot water treatment, meaning that the ILSS in warp direction was above 50 N/mm² and in weft direction was above 40 N/mm².

1. A curable composition, which comprises an epoxy resin mixture, wherein the epoxy resin mixture comprises
a) an epoxy resin;
b) diethyl methyl benzene diamine (DETDA) as hardener;
c) at least one compound selected from the group consisting of 1,8-diazabicyclo[5.4.0]undec-7-ene (DBU) and 1,5-diazabicyclo[4.3.0]non-5-ene (DBN) as catalyst.

2. The curable composition according to claim 1, wherein the epoxy resin according to a) comprises at least one epoxy resin selected from the group consisting of diglycidyl ether of bisphenol A, diglycidyl ether of bisphenol F, diglycidyl ether of hydrogenated bisphenol A, and diglycidyl ether of hydrogenated bisphenol F.

3. The curable composition according to claim 1, wherein the catalyst according to c) is present in an amount of from 0.1 to 20% by weight relative to the amount of the epoxy resin.

4. The curable composition according to claim 1, wherein the hardener according to b) is present in an amount of from 1 to 35% by weight relative to the amount of the epoxy resin.

5. The curable composition according to claim 1, wherein the epoxy resin mixture comprises
d) at least one further diamine, selected from the group consisting of cycloaliphatic diamines, meta-xylenediamine (MXDA) and meta-para-xylenediamine (MPXDA).

6. The curable composition according to claim 1, comprising
reinforcing fibers embedded in the curable composition, wherein the reinforcing fibers are selected from the group consisting of glass fiber, carbon fiber, nylon fiber and aramid fiber.

7. The curable composition according to claim 6, wherein the reinforcing fibers are present in an amount of from 10 to 80% by volume relative to the total volume of the curable composition.

8. A process for preparing a curable composition, comprising mixing of
a) an epoxy resin;
b) diethyl methyl benzene diamine (DETDA);
c) at least one compound selected from the group consisting of 1,8-diazabicyclo[5.4.0]undec-7-ene (DBU) and 1,5-diazabicyclo[4.3.0]non-5-ene (DBN).

9. A curable composition obtained or obtainable by the process of claim 8.

10. A process for the preparation of a cured epoxy resin mixture, which comprises curing a curable composition according to claim 1.

11. A cured epoxy resin which is obtained or obtainable by a process according to claim 10.

12. A process for the preparation of composite elements, which comprises
i) providing reinforcing fibers;
ii) impregnating the reinforcing fibers according to i) with a curable composition comprising an epoxy resin mixture, wherein the epoxy resin mixture comprises
a) an epoxy resin;
b) diethyl methyl benzene diamine (DETDA) as hardener;
c) at least one compound selected from the group consisting of 1,8-diazabicyclo[5.4.0]undec-7-ene (DBU) and 1,5-diazabicyclo[4.3.0]non-5-ene (DBN) as catalyst;
in order to obtain reinforcing fibers impregnated with the curable composition;
iii) applying the reinforcing fibers impregnated with the curable composition according to ii) to a surface of a support element obtaining a support element having reinforcing fibers impregnated with the curable composition on its surface;
iv) curing the curable composition;
v) optionally removing the support element.

13. The process according to claim 12, wherein the support element according to iii) has a diameter, a longitudinal extension vertically to the diameter and an outer surface parallel to the longitudinal extension and wherein applying the reinforcing fibers in iii) is done by winding the reinforcing fibers impregnated with the curable composition around the support element's outer surface.

14. A composite element which is obtained or obtainable by a process according to claim 12.

15. A method for transporting or storing liquid media, wherein the pipes, tubes or vessels comprise the composite element prepared according to the process of claim 12.

16. A process for the preparation of a cured epoxy resin mixture, which comprises curing a curable composition according to claim 9.

17. A method for transporting or storing liquid media, wherein the pipes, tubes or vessels comprise the composite element prepared according to the process of claim 14.
